(19) United States
(12) Patent Application Publication
(10) Pub. No.: US 2025/0111347 A1
(43) Pub. Date: Apr. 3, 2025

(54) DYNAMIC BILLING BASED ON STORAGE POOL ALLOCATION FOR BLOCK STORAGE

(71) Applicant: Lenovo Enterprise Solutions (Singapore) Pte. Ltd., New Tech Park (SG)

(72) Inventors: Nadia Cecilia Mosqueira, San Isidro (AR); David D. Seltzer, Petoskey, MI (US)

(21) Appl. No.: 18/374,148

(22) Filed: Sep. 28, 2023

(51) Int. Cl. G06Q 20/14; G06F 9/54; G06Q 30/04

(52) U.S. Cl. CPC G06Q 20/145; G06F 9/544; G06F 9/547; G06Q 30/04

(57) ABSTRACT

An apparatus method for dynamic billing of block storage based allocation includes a processor and computer readable media storing code. The code is executable by the processor to perform operations that include, in response to an allocation request to a client system via an allocation API over a computer network, receiving from the client system an allocated amount of block storage that is allocated to a server of the client system. The block storage is inaccessible over the computer network. The allocation request is repeated at a first interval. The operations include collecting, during a second interval, an allocated amount for each first interval, averaging the allocated amounts of the first intervals to create an averaged allocation, preparing a bill for the second interval, the bill derived from the averaged allocation and a storage allocation rate, and transmitting the bill to a user of the client system.

### FIELD

The subject matter disclosed herein relates to block storage and more particularly relates to dynamic billing based on storage pool allocation for block storage.

### BACKGROUND

Often vendors and manufacturers of data storage devices lease block storage to clients and charge a monthly fee, quarterly fee, or the like for the block storage. Block storage differs from network attached storage (“NAS”) in that block storage is local and appears as a storage device on a server. Block storage is inaccessible over a computer network and typically information about the block storage is also inaccessible over the computer network. Information about the block storage is typically provided by the client leasing the block storage, which is inconvenient and inefficient.

Often, a client will request an amount of block storage initially, but may then want additional block storage later. The block storage supplier could provide the amount of block storage requested by the client, but would then have to ship additional block storage when requested. Another approach is to ship more block storage than is requested by the client initially and then to allow the client to allocate only the amount requested initially. Later when the client wants additional block storage, the client may then allocate more block storage. However, unless the client notifies the block storage supplier about the additional block storage allocation, the supplier is unable to determine a currently allocated amount of block storage.

### BRIEF SUMMARY

An apparatus method for dynamic billing based on storage pool allocation for block storage is disclosed. A method and computer program product also perform the functions of the apparatus. The apparatus includes a processor and non-transitory computer readable media storing code. The code is executable by the processor to perform operations that include, in response to allocation request to a client system via an allocation application programming interface (“API”) over a computer network, receiving from the client system an allocated amount of block storage that is allocated to a server of the client system. The block storage is inaccessible over the computer network and the allocated amount is less than or equal to a total storage capacity of the block storage. The allocation request is repeated at a first interval. The operations include collecting, during a second interval, an allocated amount for each first interval, averaging the allocated amounts of the first intervals to create an averaged allocation, preparing a bill for the second interval, the bill derived from the averaged allocation and a storage allocation rate, and transmitting the bill to a user of the client system.

A method for dynamic billing based on storage pool allocation for block storage includes, in response to an allocation request to a client system via an allocation API over a computer network, receiving from the client system an allocated amount of block storage that is allocated to a server of the client system. The block storage is inaccessible over the computer network and the allocated amount is less than or equal to a total storage capacity of the block storage. The allocation request is repeated at a first interval. The method includes collecting, during a second interval, an allocated amount for each first interval, averaging the allocated amounts of the first intervals to create an averaged allocation, preparing a bill for the second interval, where the bill is derived from the averaged allocation and a storage allocation rate, and transmitting the bill to a user of the client system.

A program product for dynamic billing based on storage pool allocation for block storage includes a non-transitory computer readable storage medium storing code. The code is configured to be executable by a processor to perform operations that include, in response to an allocation request to a client system via an allocation API over a computer network, receiving from the client system an allocated amount of block storage that is allocated to a server of the client system. The block storage is inaccessible over the computer network and the allocated amount is less than or equal to a total storage capacity of the block storage. The allocation request is repeated at a first interval. The operations include collecting, during a second interval, an allocated amount for each first interval, averaging the allocated amounts of the first intervals to create an averaged allocation, preparing a bill for the second interval, where the bill is derived from the averaged allocation and a storage allocation rate, and transmitting the bill to a user of the client system.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for dynamic billing based on storage pool allocation for block storage, according to various embodiments;

FIG. 2 is a schematic block diagram illustrating an apparatus for dynamic billing based on storage pool allocation for block storage, according to various embodiments;

FIG. 3 is a schematic block diagram illustrating another apparatus for dynamic billing based on storage pool allocation for block storage, according to various embodiments;

FIG. 4 is a schematic flow chart diagram illustrating a method for dynamic billing based on storage pool allocation for block storage, according to various embodiments;

FIG. 5A is a first part of a schematic flow chart diagram illustrating another method for dynamic billing based on storage pool allocation for block storage, according to various embodiments; and

FIG. 5B is a second part of the schematic flow chart diagram of FIG. 5A, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R. Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

An apparatus method for dynamic billing based on storage pool allocation for block storage is disclosed. A method and computer program product also perform the functions of the apparatus. The apparatus includes a processor and non-transitory computer readable media storing code. The code is executable by the processor to perform operations that include, in response to allocation request to a client system via an allocation application programming interface (“API”) over a computer network, receiving from the client system an allocated amount of block storage that is allocated to a server of the client system. The block storage is inaccessible over the computer network and the allocated amount is less than or equal to a total storage capacity of the block storage. The allocation request is repeated at a first interval. The operations include collecting, during a second interval, an allocated amount for each first interval, averaging the allocated amounts of the first intervals to create an averaged allocation, preparing a bill for the second interval, the bill derived from the averaged allocation and a storage allocation rate, and transmitting the bill to a user of the client system.

In some embodiments, an API agent of the allocation API runs on the server of the client system. In other embodiments, the API agent accesses the allocated amount of the block storage via an operating system running on the server and transmits the allocated amount. In other embodiments, contents of the block storage and an amount of the allocated amount of the block storage currently in use are inaccessible through the API agent. In other embodiments, the second interval corresponds to a billing period and the first interval includes a time period less than or equal to the billing period.

In some embodiments, the operations include comparing the received allocation amount received via the allocation API or the averaged allocation to an allocation threshold and in response to the received allocation amount or the averaged allocation meeting or exceeding the allocation threshold, transmitting a message to a system administrator. The message triggers an action to add additional block storage to the block storage at the client system. In other embodiments, the received allocation amount received via the allocation API is less than an available amount of data storage on the block storage. In other embodiments, the block storage includes a non-volatile computer readable media device available to be mounted by the server over a client network of the client system and the block storage becomes local storage to the server after mounting.

In some embodiments, the block storage includes a plurality of non-volatile data storage devices in a storage area network (“SAN”) available to the server as a local data storage device. In other embodiments, a server transmitting the allocation request, receiving the allocated amount, collecting the allocation amount for each first interval, averaging the allocation amounts, preparing the bill, and transmitting the bill is part of a billing system and is remote from the client system.

A method for dynamic billing based on storage pool allocation for block storage includes, in response to an allocation request to a client system via an allocation API over a computer network, receiving from the client system an allocated amount of block storage that is allocated to a server of the client system. The block storage is inaccessible over the computer network and the allocated amount is less than or equal to a total storage capacity of the block storage. The allocation request is repeated at a first interval. The method includes collecting, during a second interval, an allocated amount for each first interval, averaging the allocated amounts of the first intervals to create an averaged allocation, preparing a bill for the second interval, where the bill is derived from the averaged allocation and a storage allocation rate, and transmitting the bill to a user of the client system.

In some embodiments, an API agent of the allocation API runs on the server of the client system. In other embodiments, the API agent accesses the allocated amount of the block storage via an operating system running on the server and transmits the allocated amount and/or contents of the block storage and an amount of the allocated amount of the block storage currently in use are inaccessible through the API agent. In other embodiments, the second interval corresponds to a billing period and the first interval includes a time period less than or equal to the billing period.

In some embodiments, the method includes comparing the received allocation amount received via the allocation API or the averaged allocation to an allocation threshold and, in response to the received allocation amount or the averaged allocation meeting or exceeding the allocation threshold, transmitting a message to a system administrator. The message triggers an action to add additional block storage to the block storage at the client system. In other embodiments, the received allocation amount received via the allocation API is less than an available amount of data storage on the block storage.

In some embodiments, the block storage includes a non-volatile computer readable media device available to be mounted by the server over a client network of the client system and the block storage becomes local storage to the server after mounting. In other embodiments, the block storage includes a plurality of non-volatile data storage devices in a SAN available to the server as a local data storage device. In other embodiments, a server transmitting the allocation request, receiving the allocated amount, collecting the allocation amount for each first interval, averaging the allocation amounts, preparing the bill, and transmitting the bill is part of a billing system and is remote from the client system.

A program product for dynamic billing based on storage pool allocation for block storage includes a non-transitory computer readable storage medium storing code. The code is configured to be executable by a processor to perform operations that include, in response to an allocation request to a client system via an allocation API over a computer network, receiving from the client system an allocated amount of block storage that is allocated to a server of the client system. The block storage is inaccessible over the computer network and the allocated amount is less than or equal to a total storage capacity of the block storage. The allocation request is repeated at a first interval. The operations include collecting, during a second interval, an allocated amount for each first interval, averaging the allocated amounts of the first intervals to create an averaged allocation, preparing a bill for the second interval, where the bill is derived from the averaged allocation and a storage allocation rate, and transmitting the bill to a user of the client system.

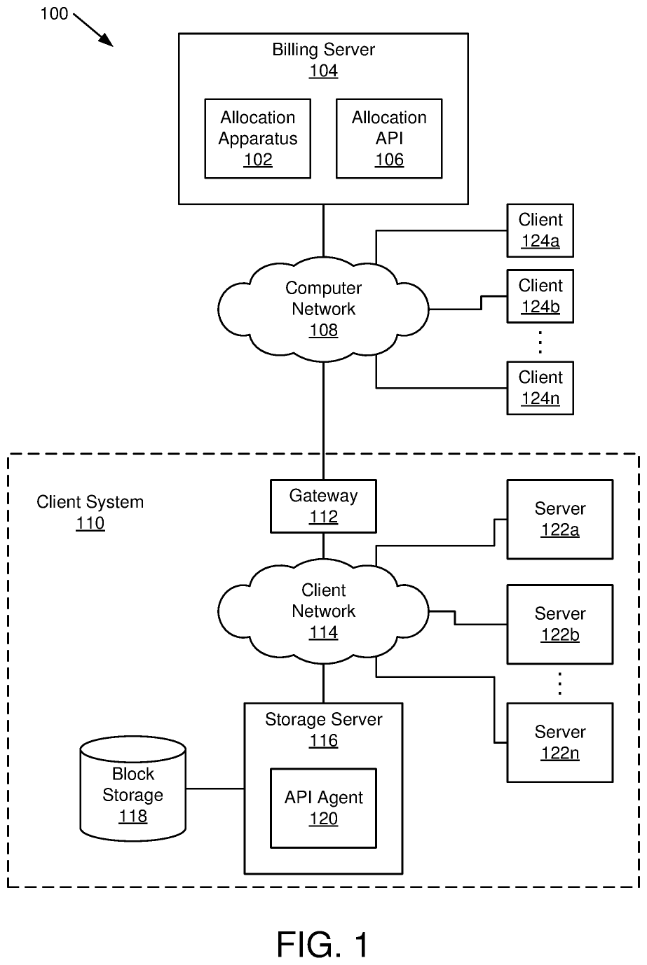

FIG. 1 is a schematic block diagram illustrating a system 100 for dynamic billing based on storage pool allocation for block storage, according to various embodiments. The system 100 includes an allocation apparatus 102, a billing server 104, an allocation application programming interface (“API”) 106, a computer network 108, a client system 110 with a gateway 112, a client network 114, a storage server 116, block storage 118, an API agent 120, and servers 122a-122n (collectively or generically “122”), and clients 124a-124n (collectively or generically “124”), which are described below.

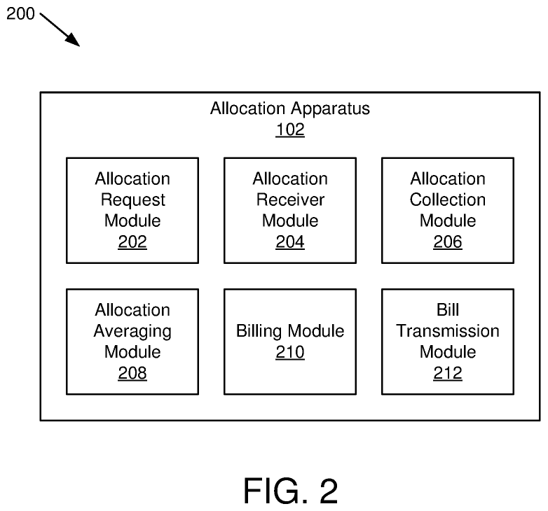

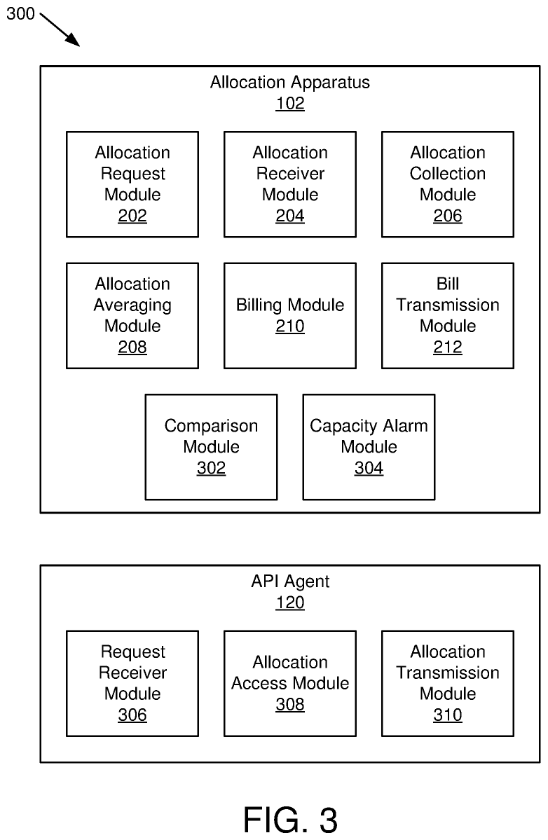

The allocation apparatus 102 transmits allocation requests over the computer network 108 using the allocation API 106 and receives an allocated amount for each allocation request from the client system 110 through the allocation API 106. The allocated amount is an amount of block storage 118 allocated by the client system 110. The block storage 118 is allocated to the storage server 116 and appears as a drive with the allocated amount and is available to devices of the client system 110, such as the servers 122. The allocation apparatus 102 transmits, during a second interval, allocation requests at a first interval, receives an allocation amount for each allocation request, and collects the allocation amounts. The allocation apparatus 102 averages allocation amounts collected during the second interval and prepares a bill derived from a storage allocation rate and the averaged allocation for the second interval. The allocation apparatus 102 is discussed further with respect to the apparatuses 200, 300 of FIGS. 2 and 3.

The billing server 104 is a server running remotely from the client system 110. Typically, an entity owns the block storage 118 and leases the block storage 118 to the client system 110 and the billing server 104 is owned or controlled by the entity that leases the block storage. In the embodiments described herein, the allocation apparatus 102 uses an allocation API 106 to access allocation information from the client system 110 over a computer network 108 and is unable to access allocation information directly from the block storage 118.

The allocation API 106, in some embodiments, is designed specifically to access allocation information of the block storage 118. Typically, the client system 110 will include an API agent 120 that is configured to access allocation information about the block storage 118 and to communication an allocated amount to the allocation API 106. In some embodiments, the API agent 120 is located on a storage server 116 or other server mounted to the block storage 118. In other embodiments, the API agent 120 is located elsewhere in the client system 110 and is capable of accessing allocation information about the block storage 118 from a server that has mounted the block storage 118.

An API is a set of designed rules or commands that enables different applications to communicate with each other. In the inventions described herein, the allocation API 106 and associated API agent 120 facilitate communication between an application on the billing server 104, such as a billing program, and an operating system of the storage server 116 that mounted the block storage 118 and controls the block storage 118. An API acts as an intermediary layer that processes data transfers between systems, which allows different systems of different computing devices, different companies, etc. to communicate and exchange data. Typically, an API is designed for applications to exchange information without user input. In some embodiments, the allocation API 106 and associated API agent 120 operate without user input to request and receive allocation information about the block storage 118. In some embodiments, contents of the block storage 118 and/or an amount of the allocated amount of the block storage 118 currently in use are inaccessible through the API agent 120. However, the allocation apparatus 102 may include a graphical user interface or other method to interact with a user to set the first interval, the second interval, a storage allocation rate, etc.

In various embodiments, the allocation API 106 and associated API agent 120 are open APIs, Partner APIs, internal APIs, or composite APIs, which are types known to those of skill in the art. Open APIs use open-source application programming interfaces accessed with Hypertext Transfer Protocol (“HTTP”). Open APIs are sometimes referred to as public APIs and have defined API endpoints and request and response formats. Partner APIs may connect business partners. In some embodiments, API developers access partner APIs through public API developer portals. Internal APIs are hidden from users and are not publicly available for users outside of a company. Internal APIs may be used to improve productivity and communication. Composite APIs are used to combine multiple data and/or services APIs and allow programmers to access several endpoints in a single call. In some embodiments, composite APIs are used in microservices architectures where performing a task may require information from more than one source. In some embodiments, the APIs may sue Simple Object Access Protocol (“SOAP”), extensible markup language (“XML”) remote procedure call (“XML-RPC”), JavaScript Object Notation remote procedure call (“JSON-RPC”), Representational State Transfer (“REST”), or the like. One of skill in the art will recognize appropriate API types useful in developing the allocation API 106 and associated API agent 120.

In other embodiments, the embodiments described herein use a communication protocol different than an API where the communication protocol is able to send allocation requests to a storage server 116 mounted to a block storage 118 and to receive allocation information about the block storage 118. In some examples, an alternative to an API is a web service, a microservice, or the like. One of skill in the art will recognize other communication protocols capable of allowing the allocation apparatus 102 to access allocation information about the block storage 118 from the client system 110.

The system 100 includes a computer network 108 that connects the billing server 104 to the client system 110. In addition, the computer network 108 may also connect various clients 124 to the client system 110, for example, where the client system 110 is a cloud computing service or other computing system accessed by various clients 124. The computer network 108, in some embodiments, includes a public computer network, such as the Internet. In various embodiments, the computer network 108 may include various public and private networks and may include a wide area network (“WAN”), a storage area network (“SAN”), a local area network (“LAN”) (e.g., a home network), an optical fiber network, the internet, or other digital communication network. In some embodiments, the computer network 108 includes a wireless connection.

The client system 110, in some embodiments, includes a client network 114, which is a digital communication network. In some embodiments, the client network 114 is a private network accessible to the billing server 104, clients 124, and other computing devices through a gateway 112. The gateway 112, in some embodiments, is a router. In other embodiments, the gateway 112 includes a firewall and helps to protect the client network 114 from unwanted communications. One of skill in the art will recognize various types of gateways 112 used between the private client network 114 and external networks, such as the computer network 108.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The client system 110 includes a storage server 116 connected to the block storage 118. In some embodiments, the storage server 116 and block storage 118 are part of a storage area network (“SAN”) accessible to the storage server 116 and other computing devices of the client system 110. In other embodiments, the storage server 116 is a general purpose server that is connected to the block storage 118. In some embodiments, the storage server 116 includes an operating system capable of mounting the block storage 118 to gain access to block storage 118. In some embodiments, mounting is a process by which a computing device's operating system makes files and directories on a data storage device or data storage system available for users to access via the computing device's operating system. In some embodiments, the storage server 116 mounting the block storage 118 creates a logical unit number (“LUN”), which is used to identify the block storage 118 when accessing files, directories, etc. of the block storage 118.

The block storage 118 is accessible through the storage server 116 and is incapable of being accessed independently through the client network 114 and/or computer network 108. Information regarding capacity, allocation, available storage space, used storage space, etc. as well as actual contents of the block storage 118 is available through the storage server 116. As a safety feature, typically the client system 110 tightly controls access to contents of the block storage as well as other properties of the block storage 118. In some examples, the client system 110 prohibits the billing server 104 from accessing contents and other properties of the block storage 118. The allocation API 106 and API agent 120 are uniquely designed to provide allocation information to the allocation apparatus 102 without providing other information about the block storage 118.

As used herein, “allocation information” includes an allocated amount as well as other information relevant to making use of the allocated amount, such as an identifier or LUN of the block storage 118, a time when the allocated amount was made available and any other information useful for the allocation apparatus 102 to bill the client system 110 for an allocated amount for the block storage 118. As used herein, “allocated amount” includes an amount of data storage allocated by the client system 110 where the allocated amount is an amount of data storage that may be used by the client system 110. The allocated amount, in some embodiments, is an amount in a relevant unit, such as bytes, kilobytes, terabytes, etc. For example, the allocated amount may be 20 terabytes. In other embodiments, the allocated amount is a percentage of a total data storage amount within the block storage 118. For example, if the total data storage capacity of the block storage 118 is 100 terabytes and the client system 110 allocates 20 terabytes, the allocated amount may be reported as 20 percent.

The allocation information, in some embodiments, includes a LUN or other identifier of the block storage 118 to allow the allocation apparatus 102 to access various client systems 110 and block storage 118 and to provide a correct bill to each client system 110. In some embodiments, the API agent 120 returns a time when an allocated amount is transmitted to the allocation apparatus 102. In other embodiments, the allocation apparatus 102 keeps track of when allocation requests are transmitted and associates the time of an allocation request with a response from the storage server 116 with an allocated amount.

The servers 122 in the client system 110 are typical computing devices that access the block storage 118 through the storage server 116. In other embodiments, the client system 110 includes other computing devices that access the block storage 118 through the storage server 116, such as printers, switches, graphical processing units (“GPUs”), accelerators, management servers, baseboard management controllers, routers, and any other computing device of the client system 110. In other embodiments, the client system 110 includes only the storage server 116, with an API agent 120, and the block storage 118. Any client system 110 with any combination of computing devices where there is a server (e.g., storage server 116) with block storage 118 is contemplated herein as being able to utilize the allocation apparatus 102 and API agent 120 to allow for dynamic billing based on allocation of storage space within the block storage 118.

The block storage 118, in some embodiments, is single data storage device. In other embodiments, the block storage 118 includes multiple data storage devices capable of being mounted as one drive or multiple drives by the storage server 116. In some examples, the block storage 118 employs some type of redundant array of independent/inexpensive disks (“RAID”), which act together to be mounted as a single drive. In other embodiments, the block storage 118 includes other redundancy methods, such as mirroring where the redundant data storage devices are capable of being accessed as a single drive. In other embodiments, the block storage 118 is divided into parts or RAID systems to be mounted as multiple drives. In some embodiments, the block storage 118 is in a single enclosure. In other embodiments, the client system 110 include multiple block storage enclosures where each enclosure reports block storage allocation separately. In such circumstances, the allocation apparatus 102 receives multiple allocated amounts where each allocated amount is from a different enclosure of block storage 118. In each embodiment, the block storage 118 is incapable of being accessed independently through the client network 114 and/or the computer network 108 and is not configured as a NAS or other network accessible storage where allocation information and other information is available directly.

In some embodiments, the block storage 118 is external to the storage server 116. In some embodiments, the block storage 118 is configured as a SAN where the storage server 116 acts as a storage controller. In other embodiments, the block storage 118 includes a separate storage controller for the SAN and the storage server 116 mounts the block storage 118 through a connection to the storage controller. In some embodiments, the block storage 118 is in a same enclosure as the storage server 116 where a combination block storage 118 and storage server 116 acts as a SAN that is accessible to the client system 110 with appropriate safeguards to prevent access by the billing server 104, computer network 108, etc. other than allocation information provided over the allocation API 106 and API agent 120 and other controlled access.

The servers 122 are computing devices that, in some embodiments, have access to the block storage 118 through the storage server 116. In some embodiments, the client system 110 is a cloud computing system and/or datacenter and the servers 122 are accessible to run workloads. In some embodiments, the servers 122 and/or the storage server 116 are rack-mounted servers. In some embodiments, the servers 122 are configured with virtual machines that are accessible to clients 124 for execution of workloads, applications, and other data processing services. In other embodiments, the servers 122 and/or clients 124 may be embodied as a desktop computer, a workstation, a server device, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device that includes a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

FIG. 2 is a schematic block diagram illustrating an apparatus 200 for dynamic billing based on storage pool allocation for block storage, according to various embodiments. The apparatus 200 includes an allocation apparatus 102 with an allocation request module 202, an allocation receiver module 204, an allocation collection module 206, and allocation averaging module 208, a billing module 210, and a bill transmission module 212, which are described below. The apparatus 200, in some embodiments, is implemented with code stored on a computer readable storage media. In other embodiments, all or a portion of the apparatus 200 is implemented using hardware circuits and/or a programmable hardware device.

The apparatus 200 includes an allocation request module 202 configured to transmit an allocation request to a client system 110 via an allocation API 106 over a computer network 108. The allocation request is a request for an allocated amount of block storage 118 that is allocated to a server (e.g., storage server 116) of the client system 110. The block storage 118 is inaccessible over the computer network 108 meaning that the block storage 118 is not connected to the computer network 108 for access and information. Instead, allocation information regarding the block storage 118 is accessible using the allocation API 106 and an associated API agent 120 on the storage server 116.

The allocated amount of the block storage 118 is less than or equal to a total storage capacity of the block storage 118. For example, if the total storage capacity is 200 terabytes, the allocated amount may be 100 terabytes, 140 terabytes, etc. up to but not exceeding 200 terabytes.

In some embodiments, the allocation request module 202 transmits the allocation request at a first time interval, such as every hour, every eight hours, every day, etc. In some embodiments, the first interval is less than a second interval, which in some embodiments, corresponds to a billing period. In other embodiments, the first interval is equal to the second interval. In the embodiments, where the second interval is a billing period, the allocation request module 202 would send out an allocation request and the allocation receiver module 204 would receive an allocated amount only once a billing period. In some examples, if the second interval is once a month, the first interval may be every hour, every day, etc.

In some embodiments, the allocation request module 202 transmits the allocation request using the allocation API 106 in a secure manner. For example, the allocation API 106 and API agent 120 may encrypt communications. In other embodiments, the allocation request module 202 cooperates with the allocation API 106 and API agent 120 to use Simple Mail Transfer Protocol (“SMTP”), HTTP, XML, JSON or the like for communications.

The apparatus 200 includes an allocation receiver module 204 configured to receive an allocated amount of the block storage 118 in response to an allocation request where the allocated amount is an amount of the block storage 118 that is currently allocated to the server (e.g., storage server 116). In some embodiments, the allocation request module 202 and the allocation receiver module 204 work in conjunction with each other to send an allocation request and to verify that a response is received with an allocated amount so that the allocation request and associated allocated amount are each for a single first interval.

The apparatus 200 includes an allocation collection module 206 configured to collect, during a second interval, an allocated amount for each first interval. In some embodiments, the allocation collection module 206 stores the allocated amounts in a register, a queue, or other data structure where the stored allocated amounts are for a particular second interval. In some embodiments, the allocation collection module 206 timestamps each of the collected allocated amounts to enable keeping allocated amounts for a second interval together. In other embodiments, the allocation collection module 206 reads timestamps included with an allocated amount to determine which allocated amounts correspond to a particular second interval. In other embodiments, allocation collection module 206 keeps a running total of the allocated amounts along with a number of first intervals as a way of collecting allocated amounts for each first interval during a second interval. One of skill in the art will recognize other ways for the allocation collection module 206 to collect allocated amounts for each first interval.

The apparatus 200 includes an allocation averaging module 208 configured to average the allocated amounts of the first intervals to create an averaged allocation. In some embodiments, the allocation averaging module 208 divides a total of the allocated amounts collected by the allocation collection module 206 by the number of first intervals in a second interval. In other embodiments, the allocation averaging module 208 uses a sum from the allocation collection module 206 and divides the sum by the number of first intervals also collected by the allocation collection module 206 or a count of the collected allocated amounts to determine the averaged allocation. Using the collected allocated amounts and an actual count of first intervals for which an averaged amount would be useful for instances where an allocation request failed. For example, if the first interval is 1 hour and the second interval is 30 days, there could be 30×24=720 first intervals in the 30-day second interval. Some of the allocation request may have failed so an accurate average would only use a number of first intervals where an allocated amount is received by the allocation receiver module 204. Where the first interval equals the second interval, the averaged allocation is equal to the single collected allocated amount.

The apparatus 200 includes a billing module 210 configured to prepare a bill for the second interval. The bill is derived from the averaged allocation and a storage allocation rate. The storage allocation rate, in some embodiments, is a monetary rate. For example, if a user of the billing server 104 charges $100 per terabyte allocated per billing cycle and the averaged allocation is 20 terabytes, the amount charged in a billing would be $100/terabyte multiplied by 20 terabytes, which equals $2000. In some embodiments, the amount charged per billing cycle is based on a complex billing rate. In some examples, the complex billing rate includes a fixed fee plus a rate multiplied by the averaged allocation. In other embodiments, billing is tiered so that the storage allocation rate changes as the averaged allocation increases. One of skill in the art will recognize other ways to use the averaged allocation to derive a bill for the second interval.

In an alternate embodiment, the billing module 210 uses a maximum allocated amount rather than an averaged allocation to derive a bill. For example, if an allocation increases part way through a second interval (e.g., billing cycle), the billing module 210 used the new allocated amount for billing rather than an averaged allocation. For example, if an allocated amount is 20 terabytes, and part way through a billing cycle the allocated amount increases to 30 terabytes, the allocation averaging module 208 is not used and the billing module 210 uses 30 terabytes to derive a bill.

The apparatus 200 includes a bill transmission module 212 configured to transmit the bill to a user of the client system. In some embodiments, the bill transmission module 212 transmits the bill to an email address or other location that is part of the client system 110. In other embodiments, the bill transmission module 212 transmits the bill to an address or location outside the client system 110.

FIG. 3 is a schematic block diagram illustrating another apparatus 300 for dynamic billing based on storage pool allocation for block storage, according to various embodiments. The apparatus 300 includes an allocation apparatus 102 with an allocation request module 202, an allocation receiver module 204, an allocation collection module 206, an allocation averaging module 208, a billing module 210, and a bill transmission module 212, which are substantially similar to those described above in relation to the apparatus 200 of FIG. 2. In various embodiments, the apparatus 300 includes a comparison module 302 and/or a capacity alarm module 304 and an API agent 120 with a request receiver module 306, an allocation access module 308, and an allocation transmission module 310, which are described below. In some embodiments, the apparatus 300 is implemented similar to how the apparatus 200 of FIG. 2 is implemented.

The apparatus 300 includes a comparison module 302 configured to compare the received allocation amount received via the allocation API 106 or the averaged allocation to an allocation threshold and a capacity alarm module 304 configured, in response to the received allocation amount or the averaged allocation meeting or exceeding the allocation threshold, transmitting a message to a system administrator. The message triggers an action to add additional block storage to the block storage 118 at the client system 110. When the allocated amount starts to approach a total capacity of the block storage 118, the owner of the block storage 118 typically would want to increase the capacity of the block storage 118 so that the client system 110 is able to continue to allocate more block storage 118 without interruption.

In some embodiments, the allocation threshold is 80 percent of the total storage capacity of the block storage 118. In other embodiments, the allocation threshold is higher or lower than 80 percent. In some embodiments, the comparison module 302 compares an allocated amount or an averaged allocation to more than one allocation threshold. In the embodiments, each allocation threshold triggers different actions, such as a first allocation may trigger a mild warning, a second allocation may trigger a higher warning, and a highest allocation threshold may trigger a highest alarm where each alarm is associated with different actions. Some actions may merely be an email, message, etc. to a system administrator. Higher actions may contact additional personnel. Some actions may include automatically ordering block storage 118, causing the additional block storage 118 to be shipped to the client system 110, scheduling installation of the block storage 118, or the like. One of skill in the art will recognize other allocation thresholds and actions to be taken based on exceeding an allocation threshold.

In some embodiments, the API agent 120 includes a request receiver module 306 configured to receive an allocation request from the allocation API 106. In some embodiments, the allocation API 106 and the API agent 120 are paired and/or include security settings so that the API agent 120 will not respond to other allocation requests. For example, the allocation apparatus 102 may include an identifier, public key, etc. in the allocation request and the request receiver module 306 receives an allocation request with a specific identifier, public key, etc. The request receiver module 306 may use a private key to decrypt all or part of the allocation request.

The API agent 120, in some embodiments, includes an allocation access module 308 that accesses a current allocated amount of the block storage 118. In some embodiments, the allocation access module 308 accesses an operating system of the storage server 116 to access properties of the block storage 118 kept by the storage server 116 to retrieve the current allocated amount. In other embodiments, the allocation access module 308 accesses a log of allocation commands to access a latest allocation command that was used to allocate a certain amount of the total storage capacity of the block storage 118. One of skill in the art will recognize other ways for the allocation access module 308 to access a current allocated amount of the block storage 118 and other related information.

The API agent 120, in some embodiments, includes an allocation transmission module 310 configured to transmit an allocated amount to the allocation API 106 in the billing server 104 in response to the allocation request and to the allocation access module 308 retrieving a current allocated amount of the block storage 118. In some embodiments, the allocation transmission module 310 transmits the allocated amount in a secure way, such as by encrypting a message with the allocated amount using a private key.

Beneficially, the allocation apparatus 102 and associated allocation API 106 and API agent 120 provide a mechanism to access a current allocation of the block storage 118 of a client system 110 without depending on someone associated with the client system 110 having to provide the allocated amount. Having the allocated amount instead of just the total storage capacity of the block storage 118 provides a way to bill based on the allocated amount rather than the total storage capacity of the block storage 118, which then allows the owner of the block storage 118 to ship more block storage 118 than the client needs and provides an easy way for the client to increase storage capacity without the owner of the block storage 118 having to come to the client system 110. In addition, the allocation apparatus 102 and associated allocation API 106 and API agent 120 provide a mechanism to access allocation information from the block storage 118 that is not normally available due to the nature of the block storage 118 being local and not network attached storage. Also, the allocation apparatus 102 and associated allocation API 106 and API agent 120 provide a way to access an allocated amount without gaining access to contents of the block storage or accessing information about how much of the allocated amount of the block storage 118 is currently in use.

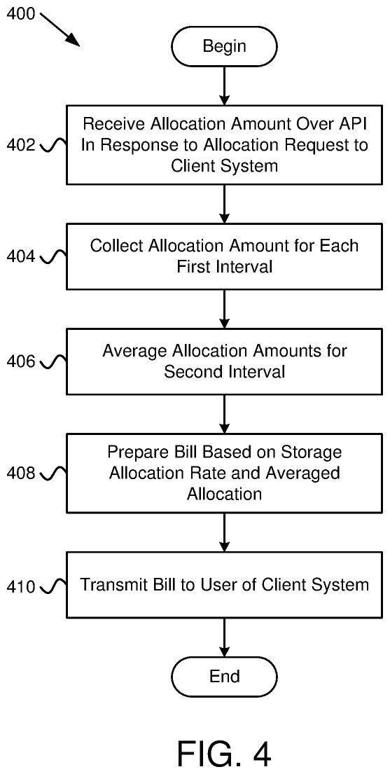

FIG. 4 is a schematic flow chart diagram illustrating a method 400 for dynamic billing based on storage pool allocation for block storage, according to various embodiments. The method 400 begins and receives 402, in response to allocation request to a client system 110 via an allocation API 106 over a computer network 108, from the client system 110 an allocated amount of block storage 118 that is allocated to a server (e.g., storage server 116) of the client system 110. The block storage 118 is inaccessible over the computer network 108 and the allocated amount less than or equal to a total storage capacity of the block storage 118. The allocation request is repeated at a first interval.

The method 400 collects 404, during a second interval, an allocated amount for each first interval and averages 406 the allocated amounts of the first intervals to create an averaged allocation. The method 400 prepares 408 a bill for the second interval. The bill is derived from the averaged allocation and a storage allocation rate. The method 400 transmits 410 the bill to a user of the client system 110, and the method 400 ends. In various embodiments, all or a portion of the method 400 is implemented with the allocation request module 202, the allocation receiver module 204, the allocation collection module 206, the allocation averaging module 208, the billing module 210, and/or the bill transmission module 212.

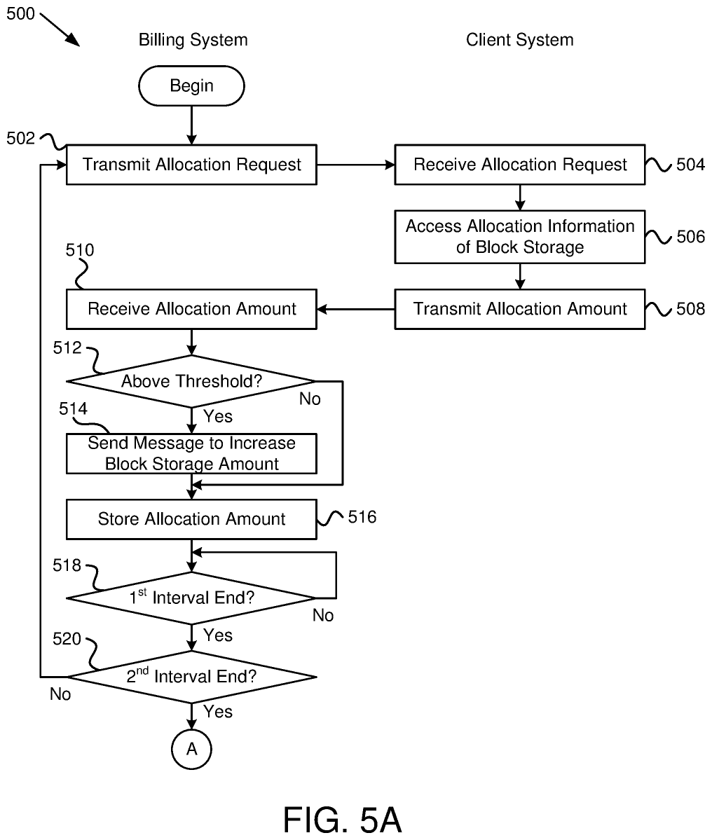

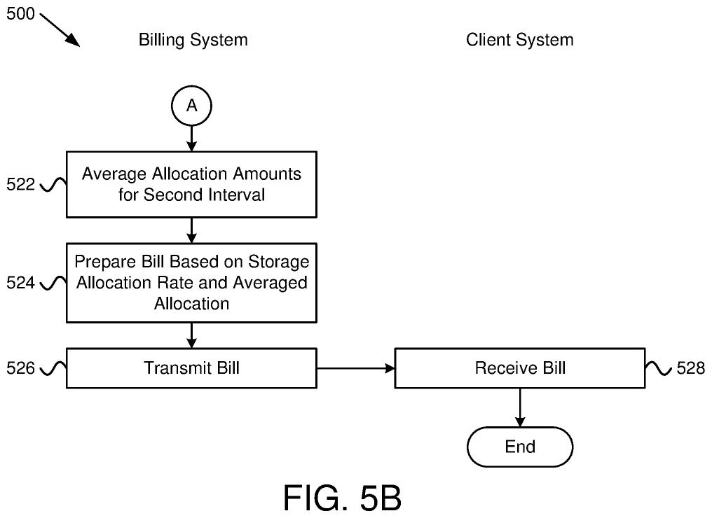

FIG. 5A is a first part and 5B is a second part of a schematic flow chart diagram illustrating another method 500 for dynamic billing based on storage pool allocation for block storage, according to various embodiments. The method 500 begins and, from a billing system, transmits 502 an allocation request to a client system 110 via an allocation API 106 over a computer network 108. The block storage 118 is inaccessible over the computer network 108 and the allocated amount is less than or equal to a total storage capacity of the block storage 118. The method 500 receives 504, at the client system 110, the allocation request and accesses 506 allocation information about the block storage 118, including a currently allocated amount of the block storage 118. The method 500 transmits 508, from the client system 110, the current allocated amount of the block storage 118 to the allocation API 106 of the billing server 104.

At the billing system, the method 500 receives 510 from the client system 110 an allocated amount of the block storage 118 that is allocated to a server (e.g., storage server 116) of the client system 110 and determines 512 if the allocated amount is above an allocation threshold. If the method 500 determines 512 that the allocated amount is above the allocation threshold, the method 500 sends 514 a message to increase the amount of block storage 118. The message may be sent to a system administrator of an owner of the block storage 118, to a company that ships block storage 118, or other location where the receiver of the message takes various actions in response to the message to increase the block storage 118. If the method 500 determines 512 that the allocated amount does not exceed the allocation threshold, the method 500 bypasses sending 514 the message to increase the block storage 118.

The method 500, at the billing system, stores 516 the allocated amount. In addition, the method 500 may also store a time of the allocation request and/or a time of the received allocated amount, or other indicator of the time interval that corresponds to the received allocated amount. The method 500 determines 518 if the first interval has ended. If the method 500 determines 518 that the first interval has not ended, the method 500 returns and waits for the first interval to end. If the method 500 determines 518 that the first interval has ended, the method 500 determines 520 if the second interval has ended. If the method 500 determines 520 that the second interval has not ended, the method 500 returns and transmits 502 another allocation request. If the method 500 determines 520 that the second interval has ended, the method 500 averages 522 the allocated amounts of the first intervals to create an averaged allocation (follow “A” on FIG. 5A to “A” on FIG. 5B).

The method 500 prepares 524 a bill for the second interval where the bill is derived from the averaged allocation and a storage allocation rate and transmits 526 the bill to a user of the client system 110. At the client system 110, the method 500 receives 528 the bill, and the method 500 ends. In various embodiments, all or a portion of the method 500 is implemented using the allocation request module 202, the allocation receiver module 204, the allocation collection module 206, the allocation averaging module 208, the billing module 210, the bill transmission module 212, the comparison module 302, the capacity alarm module 304, the allocation API 106, the API agent 120, the request receiver module 306, the allocation access module 308, and/or the allocation transmission module 310.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor; and
non-transitory computer readable storage media storing code, the code being executable by the processor to perform operations comprising:
in response to an allocation request to a client system via an allocation application programming interface (“API”) over a computer network, receiving from the client system an allocated amount of block storage that is allocated to a server of the client system, the block storage being inaccessible over the computer network, the allocated amount less than or equal to a total storage capacity of the block storage, wherein the allocation request is repeated at a first interval;
collecting, during a second interval, an allocated amount for each first interval;
averaging the allocated amounts of the first intervals to create an averaged allocation;
preparing a bill for the second interval, the bill derived from the averaged allocation and a storage allocation rate; and
transmitting the bill to a user of the client system.

2. The apparatus of claim 1, wherein an API agent of the allocation API runs on the server of the client system.

3. The apparatus of claim 2, wherein the API agent accesses the allocated amount of the block storage via an operating system running on the server and transmits the allocated amount.

4. The apparatus of claim 2, wherein contents of the block storage and an amount of the allocated amount of the block storage currently in use are inaccessible through the API agent.

5. The apparatus of claim 1, wherein the second interval corresponds to a billing period and the first interval comprises a time period less than or equal to the billing period.

6. The apparatus of claim 1, the operations further comprising:
comparing one of the received allocation amount received via the allocation API or the averaged allocation to an allocation threshold; and
in response to the received allocation amount or the averaged allocation meeting or exceeding the allocation threshold, transmitting a message to a system administrator, the message triggering an action to add additional block storage to the block storage at the client system.

7. The apparatus of claim 1, wherein the received allocation amount received via the allocation API is less than an available amount of data storage on the block storage.

8. The apparatus of claim 1, wherein the block storage comprises a non-volatile computer readable media device available to be mounted by the server over a client network of the client system and wherein the block storage becomes local storage to the server after mounting.

9. The apparatus of claim 1, wherein the block storage comprises a plurality of non-volatile data storage devices in a storage area network (“SAN”) available to the server as a local data storage device.

10. The apparatus of claim 1, wherein a server transmitting the allocation request, receiving the allocated amount, collecting the allocation amount for each first interval, averaging the allocation amounts, preparing the bill, and transmitting the bill is part of a billing system and is remote from the client system.

11. A method comprising:
in response to an allocation request to a client system via an allocation application programming interface (“API”) over a computer network, receiving from the client system an allocated amount of block storage that is allocated to a server of the client system, the block storage being inaccessible over the computer network, the allocated amount less than or equal to a total storage capacity of the block storage, wherein the allocation request is repeated at a first interval;
collecting, during a second interval, an allocated amount for each first interval;
averaging the allocated amounts of the first intervals to create an averaged allocation;
preparing a bill for the second interval, the bill derived from the averaged allocation and a storage allocation rate; and
transmitting the bill to a user of the client system.

12. The method of claim 11, wherein an API agent of the allocation API runs on the server of the client system.

13. The method of claim 12, wherein the API agent accesses the allocated amount of the block storage via an operating system running on the server and transmits the allocated amount and/or wherein contents of the block storage and an amount of the allocated amount of the block storage currently in use are inaccessible through the API agent.

14. The method of claim 11, wherein the second interval corresponds to a billing period and the first interval comprises a time period less than or equal to the billing period.

15. The method of claim 11, further comprising:
comparing one of the received allocation amount received via the allocation API or the averaged allocation to an allocation threshold; and
in response to the received allocation amount or the averaged allocation meeting or exceeding the allocation threshold, transmitting a message to a system administrator, the message triggering an action to add additional block storage to the block storage at the client system.

16. The method of claim 11, wherein the received allocation amount received via the allocation API is less than an available amount of data storage on the block storage.

17. The method of claim 11, wherein the block storage comprises a non-volatile computer readable media device available to be mounted by the server over a client network of the client system and wherein the block storage becomes local storage to the server after mounting.

18. The method of claim 11, wherein the block storage comprises a plurality of non-volatile data storage devices in a storage area network (“SAN”) available to the server as a local data storage device.

19. The method of claim 11, wherein a server transmitting the allocation request, receiving the allocated amount, collecting the allocation amount for each first interval, averaging the allocation amounts, preparing the bill, and transmitting the bill is part of a billing system and is remote from the client system.

20. A program product comprising a non-transitory computer readable storage medium storing code, the code being configured to be executable by a processor to perform operations comprising:
in response to an allocation request to a client system via an allocation application programming interface (“API”) over a computer network, receiving from the client system an allocated amount of block storage that is allocated to a server of the client system, the block storage being inaccessible over the computer network, the allocated amount less than or equal to a total storage capacity of the block storage, wherein the allocation request is repeated at a first interval;
collecting, during a second interval, an allocated amount for each first interval;
averaging the allocated amounts of the first intervals to create an averaged allocation;
preparing a bill for the second interval, the bill derived from the averaged allocation and a storage allocation rate; and
transmitting the bill to a user of the client system.
